(19) United States
(12) Patent Application Publication
(10) Pub. No.: US 2006/0294565 A1
(43) Pub. Date: Dec. 28, 2006

(54) Television-based security monitoring system

(75) Inventor: Edward Walter, Boerne, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/448,436

(22) Filed: Jun. 6, 2006

Related U.S. Application Data
(63) Continuation-in-part of application No. 11/166,909, filed on Jun. 24, 2005.
(63) Continuation-in-part of application No. 11/166,785, filed on Jun. 24, 2005.
(63) Continuation-in-part of application No. 11/166,908, filed on Jun. 24, 2005.
(63) Continuation-in-part of application No. 11/166,907, filed on Jun. 24, 2005.
(63) Continuation-in-part of application No. 11/298,202, filed on Dec. 9, 2005.

(51) Int. Cl. H04N 7/173; H04N 7/16

(52) U.S. Cl. 725/108; 725/132; 725/140; 725/152

(57) ABSTRACT

In an embodiment, a system includes a processor configured to be coupled to a packet-based network. The processor is further coupled to a television display, a video sensor, an alarm sensor, and a modular card. The modular card includes a control module having logic to transmit an electronic message. The electronic message includes a link back to the system.

### RELATED APPLICATIONS

This application is a continuation-in-part, and claims priority to U.S. patent application Ser. No. 11/166,909, filed on Jun. 24, 2005, and entitled “Network Television and Method Thereof”; U.S. patent application Ser. No. 11/166,785, filed on Jun. 24, 2005, and entitled “Multi-Media Based Video Game Distribution”; U.S. patent application Ser. No. 11/166,908, filed on Jun. 24, 2005, and entitled “Video Game Console Modular Card and Method Thereof”; U.S. patent application Ser. No. 11/166,907, filed on Jun. 24, 2005, and entitled “Audio Receiver Modular Card and Method Thereof”; and U.S. patent application Ser. No. 11/298,202, filed on Dec. 9, 2005, and entitled “Security Monitoring Using A Multimedia Processing Device.” Each of the foregoing patent applications is hereby incorporated by reference in their entirety for all purposes.

### TECHNICAL FIELD

Various embodiments relate to security systems, and in an embodiment, but not by way of limitation, to security systems coupled to multimedia processing devices.

### BACKGROUND

Conventional consumer and business physical security monitoring systems typically are implemented as a central alarm panel connected via wiring to one or more alarm sensors at various locations of the monitored premises. The alarm panel is typically implemented as a set of buttons, light emitting diodes, and/or alphanumeric displays that provide a limited indication of the current alarm status of the monitored premises. However, such indicators are often inadequate for the purpose of rapidly conveying sufficient video information to a user since the relationship between the indicators and their corresponding alarm sensor often is not readily apparent, and many conventional alphanumeric displays are capable of displaying only a limited amount of information at any given moment. Consequently, a user may have difficulty in quickly assessing the alarm status of the monitored premises. Additionally, the alarm panel, by the nature of the security system wiring, typically is centrally located in a hallway or near an entrance so that it may be quickly armed and disarmed upon a user's departure or arrival. Unfortunately, these particular locations are typically inconvenient to a user who might be resting or relaxing in another room. The alarm panels are even more inconvenient and practically useless if a person is not at home at the time of a breach. Accordingly, an improved technique for providing security monitoring would be advantageous.

### BRIEF DESCRIPTION OF THE DRAWINGS

Various embodiments are pointed out with particularity in the appended claims. However, other features are described in the following detailed description in conjunction with the accompanying drawings in which:

FIG. 1 illustrates an embodiment of a multimedia processing device such as a networked television.

FIG. 2 illustrates a block diagram of an architecture of the networked television of FIG. 1.

FIG. 3 illustrates a block diagram of an embodiment of a multimedia decoder modular card architecture.

FIG. 4 illustrates an example embodiment of networked television coupled to a network.

FIG. 5 illustrates a block diagram of an example embodiment of a security monitoring modular card architecture.

FIG. 6 illustrates an embodiment of a graphical user interface of a premises diagram.

FIG. 7 illustrates a graphical user interface of a premises diagram and one or more alarm statuses.

FIG. 8 illustrates an example embodiment of a process for monitoring security via a multimedia device.

FIG. 9 illustrates another example embodiment of a process for monitoring security via a multimedia device.

FIG. 10 illustrates an embodiment of a computer architecture upon which an embodiment of a networked television may operate.

FIG. 11 illustrates an embodiment of a system to transmit an electronic notification with an embedded link.

### DETAILED DESCRIPTION

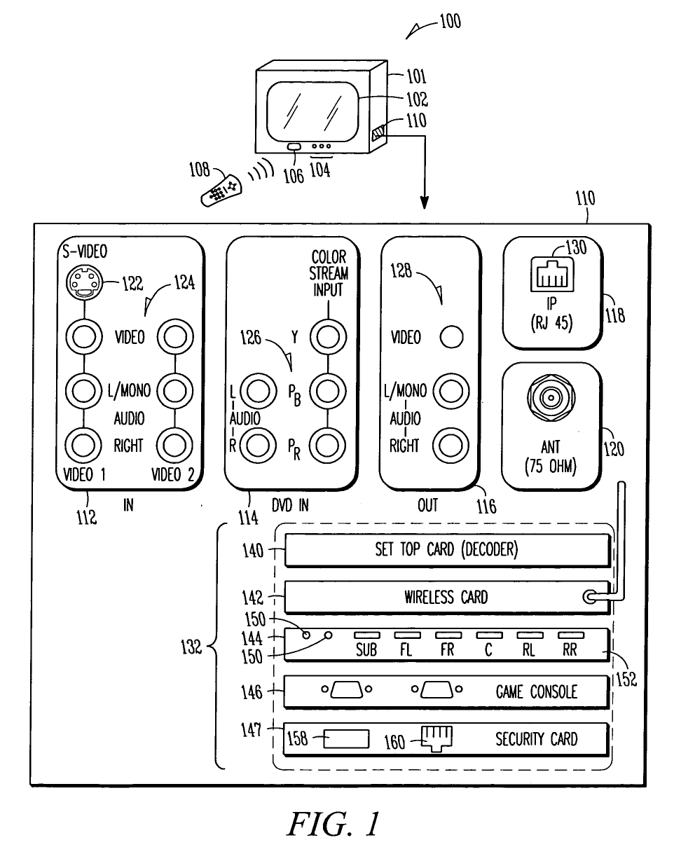

Referring to FIG. 1, an example embodiment of a multimedia processing device such as a networked television 100 is illustrated in accordance with at least one embodiment of the present disclosure. As depicted, the television 100 includes a housing 101 that contains a display 102 (e.g., a liquid crystal display or a plasma display). Further, the housing 101 includes a plurality of user interface buttons 104, such as a power button, channel change buttons, volume control buttons, and the like. The housing 101 also includes a remote control interface 106, for example an infrared interface or a radio frequency (RF) interface, to receive remote control commands from a remote control 108. In a particular embodiment, one or more operations of the television 100 are responsive to the remote control commands. The television 100 further includes an interface panel 110 that is accessible via an external surface of the housing 101, for example at a top, back or side surface of the housing 101. The interface panel 110 includes one or more interfaces for receiving or outputting various forms of multimedia data. As shown, the interface panel 110 includes an IN component 112 that includes, for example, an S-video receptacle 122 and audio-visual receptacles 124, and a digital versatile disk (DVD) IN component 114 that is configured to receive video data and audio data from an external DVD player or other multimedia source. In particular, the DVD IN component 114 includes a plurality of receptacles 126 that can receive component video and audio. The panel 110 also can include an OUT component 116 that has receptacles 128 to provide video data and/or audio data to another television or recording device, such as a personal video recorder (PVR) or an external DVD player/recorder. An RF antenna receptacle 120 also can be incorporated into the panel 110 to receive multimedia data via RF transmissions.

In at least one embodiment, the panel 110 further includes a network interface 118 that includes a network receptacle 130 that can be connected to any of a variety of packet-based data networks. The receptacle 130 can be connected to an Internet Protocol (IP)-based network, for example an Ethernet network or an asynchronous transfer mode (ATM)-based network. Further, in a particular embodiment, the network interface 118 can include an Ethernet interface, and as such, the network receptacle 130 can be an RJ-45 receptacle that is configured to receive an Ethernet cable that is connected to an Ethernet-based network. The television 100 can utilize the network interface 118 to receive multimedia data, for example video data, audio data, or video game data, over a packet-based network for processing at the television 100. Moreover, the network interface 118 may be used by the television 100 to forward information to another networked device, such as another networked television 100. The forwarded information may include, for example, processed multimedia data or information associated with the multimedia data, information associated with a video game being played at the television 100, and the like. In another embodiment, the television 100 can utilize the network interface 118 to receive alarm sensor data directly from one or more alarm sensors positioned around monitored premises or via an alarm panel that is connected to the alarm sensors.

As illustrated in FIG. 1, the panel 110 further can include one or more modular card receptacles 132 (also commonly referred to as “expansion slots”) to interface with one or more modular cards (also commonly referred to as “expansion cards”) to enhance the functionality of the television 100. The modular cards can include, for example, a multimedia decoder modular card 140, a wireless network interface modular card 142, an audio receiver modular card 144, a video game console modular card 146, a security monitoring modular card 147, and the like. In a particular embodiment, the modular card receptacles 132 and the corresponding modular cards 140, 142, 144, 146, and 147 may be implemented using a standard architecture, such as a Peripheral Component Interconnect (PCI)-compliant architecture, an Industry Standard Architecture (ISA)-compliant architecture, or a Personal Computer Memory Card International Association (PCMCIA)-compliant architecture. Alternatively, the modular card receptacles 132 and the corresponding modular cards 140, 142, 144, 146, and 147 may be implemented using a proprietary architecture, or a combination of standard and proprietary architectures.

To customize the functionality of the television 100, modular cards may be added or removed from the television by inserting or removing the modular cards from their corresponding modular card receptacles. For example, the panel 110 may include an opening in the housing for each modular card receptacle 132 and each modular card receptacle 132 may receive a modular card that is inserted through the corresponding opening so that the contacts of the modular card receptacle interface are brought into secure contact with the contacts of the receiving modular card receptacle 132. Alternatively, part or all of the panel 110 can be temporarily removed to install the modular card in a modular card receptacle 132. In at least one embodiment, some or all of the modular cards may include one or more interface receptacles that are accessible at the panel 110 to interface with other components.

In a particular embodiment, the incorporation of one or more modular cards into the television 100 allows for an expansion of the available functionality of the television 100. For example, the television 100 may incorporate the wireless network interface modular card 142 to provide wireless connectivity for the transmission of information to other networked devices. Moreover, the television 100 may incorporate the multimedia decoder modular card 140 to process multimedia data. The processing performed by the multimedia decoder modular card 140 may include, for example, decoding or transcoding encoded multimedia data, encoding non-coded multimedia data, decrypting encrypted multimedia data, and the like.

In an embodiment, the multimedia data processed by the decoder modular card 140 may be obtained from an external multimedia device, such as a DVD player, via the interfaces 122-128. Alternatively, the multimedia data may be received as a multimedia data stream via the network interface 118 or via the wireless interface modular card 142. The video content of the resulting processed multimedia data may be displayed on the display 102 or the resulting processed multimedia data may be provided to one or more networked devices via the network interface 118 or the wireless network interface modular card 142.

The television 100 can also incorporate the audio receiver modular card 144 to process audio data for output to one or more speakers. In one embodiment, the audio receiver modular card 144 provides many of the features commonly found in separate stereo receivers. The audio data may be received from an external audio device, e.g., a portable music player, via one or more audio inputs 150. Alternatively, the audio data may be received via the network interface 118 or the wireless network interface modular card 142. The resulting processed audio data may be provided to one or more wired speakers via speaker outputs 152 or the resulting processed audio data may be provided to one or more wireless speakers via, for example, the wireless network interface modular card 142.

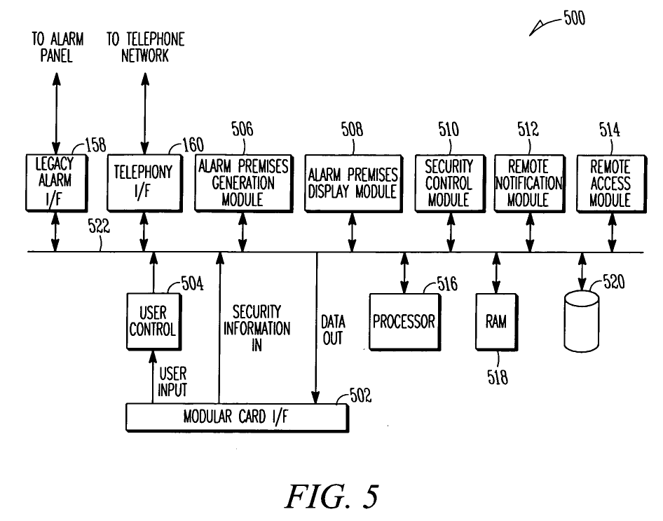

The television 100 additionally may incorporate the security monitoring modular card 147 to provide premises security information for display via the display 102. The physical security system can include, for example, a graphical user interface (GUI) having a premises diagram that represents the layout of the monitored premises, including the types and locations of various alarm sensors and their current status (e.g., ready, armed, error, breached, etc.). The security monitoring modular card 147 also may provide a GUI to facilitate the generation of the premises diagram by a user via, for example, the remote control 108 and the remote control interface 106. Alarm sensor information representative of the status of the system can be received via the network interface 118, via the wireless modular card 142, or via a legacy alarm panel interface 158 of the security monitoring modular card 147. Further, in at least one embodiment, an integrated security card may implement the functions of the network interface 118, the wireless modular card 142, or a telephone interface 160 to contact a security operations entity (e.g., law enforcement or a security monitoring service) for premises breach notification purposes. Various exemplary techniques for security monitoring by the security monitoring console modular card 147 are discussed in greater detail herein with reference to FIGS. 5-8.

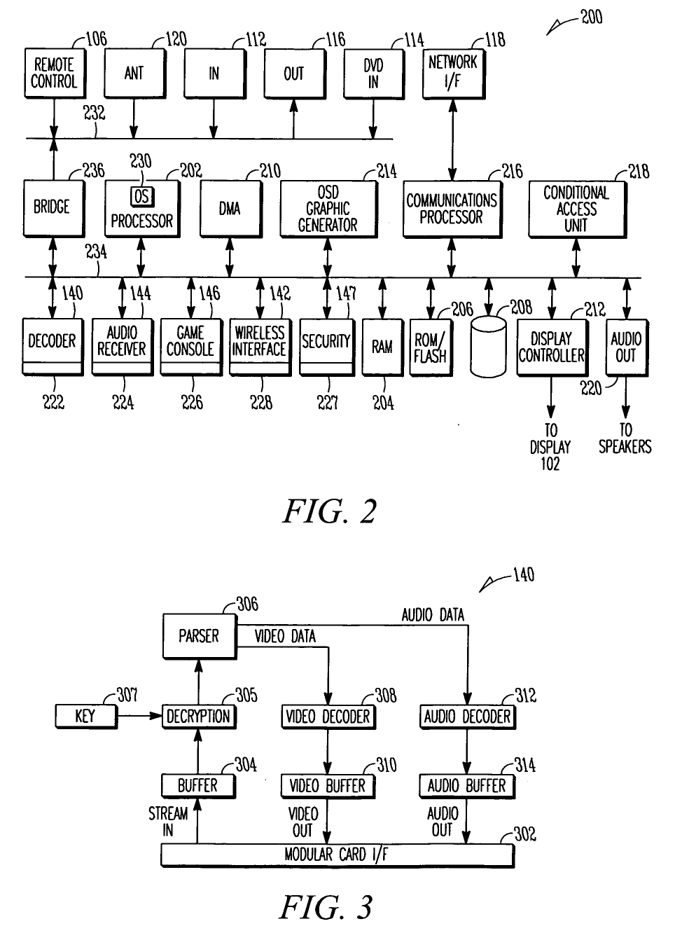

Referring to FIG. 2, an example embodiment of an architecture 200 of the television 100 is illustrated in accordance with at least one embodiment of the present disclosure. The television 100 includes one or more processors 202 (which in an embodiment may be referred to as television-based processors), one or more storage devices, such as a random access memory (RAM) 204, a read only memory (ROM) or flash memory 206 or a hard disk 208, a direct memory access controller (DMA) 210 and a display controller 212 coupled to the display 102 (FIG. 1). The television 100 also can include an overlay graphics generator 214, a network communications processor 216 connected to the network interface 118, a conditional access unit 218, and an audio output 220. The television 100 further can include modular card receptacles 222, 224, 226, 227, and 228 connected to the multimedia decoder modular card 140, the audio receiver modular card 144, the video game console modular card 146, the security modular monitoring card 147, and the wireless network interface modular card 142, respectively. As depicted in FIG. 2, the television 100 can further include the remote control interface 106, the RF antenna interface 120, the IN component 112, the OUT component 116, and the DVD IN component 114 of the panel 110 (FIG. 1). In the illustrated example, some components of the television 100 can be connected to a first bus 232 while other components can be connected via a second bus 234. Further, the busses 232, 234 can be connected by a bridge bus 236.

During operation, the various components of the television 100 communicate information via the busses 232, 234 in order to perform various multimedia related functions. For example, the communications processor 216 provides communications protocol specific processing for data received via the network interface 118 and for data to be transmitted on a packet based network via the network interface 118. Further, the communications processor 216 may implement one or more functions associated with, the Open Systems Interconnection (OSI) seven layer model or the Telecommunications Protocol/Internet Protocol (TCP/IP) stack. During operation, incoming data that is processed by the communications processor 216 can be routed to one or more of the components of the television 100 as appropriate. The DMA controller 210 can control access to the RAM 204 and/or the ROM 206 by the components of the television 100. Moreover, the overlay graphics generator 214 can generate overlay graphics that overlay the display graphics that are output to the display 102 by the display controller 212.

In a particular embodiment, the modular cards 140-147 may communicate information with each other and with other components of the television, for example, the processor 202 or the display controller 212, using the modular card receptacles 222-228 and the bus 234. For example, the wireless network interface modular card 142 or the network interface 118 may be used to receive/transmit audio data for the audio receiver modular card 144, or receive/transmit video game data and related information for the video game consol modular card 146. Alternatively, multimedia data or video game data may be received via one or more of the RF antenna interface 120, the IN component 112, of the DVD IN component 114. Further, video data that represents video content may be provided from the decoder modular card 140 or the video game console modular card 146 to the display controller 212 so that the video content is displayed by the display 102. Similarly, audio data representing audio content may be provided from the audio receiver modular card 144 to the audio output 220 for output of the audio content by one or more speakers of the television 100. Additionally, security information for processing may be provided from the wireless interface modular card 142 or the network interface 118 to the security monitoring modular card 227. Likewise, display information generated by the security monitoring modular card 227 may be processed for display by the display controller 212.

Referring to FIG. 3, an example embodiment of the multimedia decoder modular card 140 is illustrated in accordance with at least one embodiment of the present disclosure. In the example depicted, the multimedia decoder modular card 140 includes a modular card receptacle interface 302, an input buffer 304, a decryption module 305, a parser 306, a video decoder 308, a video output buffer 310, and an audio decoder 312 and an audio output buffer 314. In a particular embodiment, the incoming buffer 304 and the output buffers 310 and 314 may be implemented together as a single buffer.

During operation, incoming multimedia data that is to be processed by the decoder modular card 140 is buffered in the incoming buffer 304. In at least one embodiment, the multimedia data is part of an MPEG data stream. Accordingly, the parser 306 parses the multimedia data to identify the relevant video and/or audio data to be processed. Then, the parser 306 provides the video data to the video decoder 308. The video decoder 308 decodes, or transcodes, the video data and the resulting decoded/transcoded data can be stored in the outgoing video buffer 310 before being provided to the bus 234 (FIG. 2) for transmission to one or more components of the television 100. Similarly, the audio decoder 312 decodes or transcodes the audio data. Audio data is decoded/transcoded by the audio decoder 312 and the resulting decoded/transcoded audio data is buffered in the outgoing audio buffer 314 before being provided to the bus 234 for transmission to one or more other components of the television 100.

Alternatively, in one embodiment, the received multimedia data includes non-coded multimedia data. In this instance, the video decoder 308 also may provide a video encoder to encode the video data to generate encoded video data, for example MPEG data, and the audio decoder 312 may include an audio encoder to encode the audio data to generate encoded audio data.

In at least one embodiment, the received multimedia data is encrypted or otherwise protected to prevent unauthorized access to the multimedia content. Accordingly, in at least one embodiment, the integrated decoder modular card 140 further comprises a decryption module 305 to process the protected multimedia data to generate unprotected multimedia data using a decryption key 307 supplied by, for example, a provider of the protected multimedia data. In one embodiment, the decryption module 305 processes the protected multimedia data before it is provided to the parser 306. Alternatively, the decryption module 305 could be implemented at the output of the parser 306 or as part of the decoders 308 and 312.

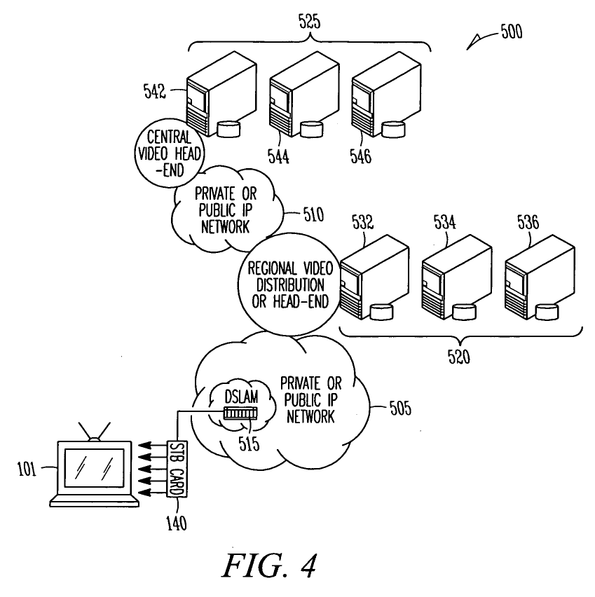

FIG. 4 illustrates an example of the connection of a television such as the one illustrated in FIGS. 1 and 2, or other multimedia processing device, to a network. Referring to FIG. 4, a system 400 includes a television 101, a set top box card 140, and one or more public or private networks 405 and 410. The network 405 to which the STB card 140 is connected may include a digital subscriber line access multiplexer (DSLAM) 415. The television 101 may be connected to regional video distribution servers 420 and/or central video distribution servers 425 via the networks 405 and 410. The regional server 420 may include a channel content application server 432, a content burst application server 434, and a user configuration preload database 436. Similarly, the central server 425 may include a channel content application server 442, a content burst application server 444, and an audience measurement and tracking server 446.

Referring to FIG. 5, an embodiment of an implementation of the security monitoring card 147 of FIG. 1 is illustrated in accordance with at least one embodiment of the present invention. In FIG. 5, the security monitoring modular card 147 includes a legacy alarm panel interface 158, a telephony interface 160, a modular card receptacle interface 502, a user control module 504, an alarm premises generation module 506, an alarm premises display module 508, a security control module 510, a remote notification module 512, a remote access module 514, a processor 516, memory 518 (e.g., random access memory (RAM)), and mass storage 520 (e.g., a flash memory or hard drive)). The components of the security monitoring modular card 147 may be implemented as hardware, firmware, software, or combinations thereof. To illustrate, the modules 504, 506, 508, 510, 512, and 514 may be implemented, in whole or in part, as one or more computer programs represented as instructions stored in the memory 518 and executed by the processor 516 to perform the processes described herein.

During operation, security information to be processed by the security monitoring modular card 147 is received via the modular card interface 502. The security information may be received at the television 100 via the network interface 118 (FIG. 1), the wireless modular card 142 (FIG. 1), or the legacy alarm panel interface 158. The security information may include, for example, alarm sensor information, user premises layout information, alarm action command information, and the like. The alarm sensor information includes information from one or more alarm sensors, such as, for example, video data from a security camera, status information (e.g., armed, unarmed, breached) from a door sensor, window sensor, trip sensor (e.g., infrared light sensor), and ultrasonic window breakage sensor, and the like. Similarly, data generated by the security monitoring modular card 147, such as display information representing a monitored premises layout, alarm statuses, potential breaches, and the like, may be provided for output to other components of the television via the modular card receptacle interface 502. Alarm sensor information may be provided from alarm sensors to the television 100 as an analog signal transmitted over wiring connecting the sensors to an alarm panel or directly to the television 100. Alternatively, one or more of the alarm sensors may be connected to a data network whereby alarm sensor information is transmitted via the data network. Further, in at least one embodiment, one or more of the alarm sensors may include a wireless transmitter, such as a Bluetooth-based transmitter or an IEEE 802.11-based transmitter, to wirelessly communicate alarm sensor information to an alarm panel or the television 100 via, for example, the wireless interface modular card 142 (FIG. 1).

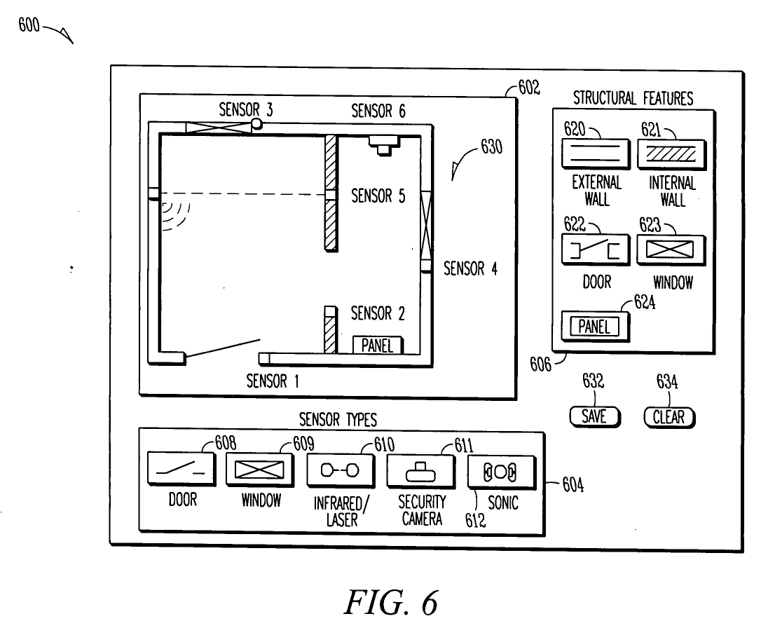

The alarm premises generation module 506 facilitates the generation of a premises diagram that represents the layout of the monitored premises, including the locations of various alarm sensors and their statuses. In one embodiment, the alarm premises generation module 506 provides a premises diagram generation GUI for display whereby a user can interact with the GUI via remote control commands, for example, to provide premises information used by the alarm premises generation module 506 to generate the premises diagram. The premises information may be received at and processed by the user control module 504 to generate diagram input for use by the alarm premises generation module 506. The alarm premises generation module 506 may implement a standard graphical drawing program, such as AutoCAD, Microsoft Visio, Microsoft PowerPoint, or a proprietary interface to facilitate the creation of the premises layout. An illustrative implementation of a premises diagram generation GUI is discussed in greater detail with reference to FIG. 6.

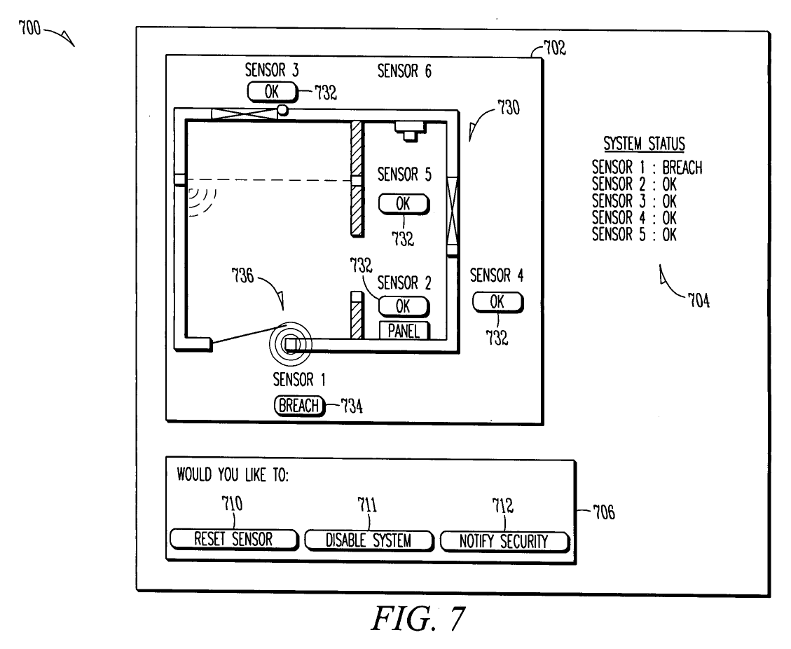

Data representative of the generated premises diagram is used by the alarm premises display module 508 to generate a premises status GUI for display. The premises status GUI includes the generated premises diagram, as well as visual and/or audible representations of the alarm status of more or more of the alarm sensors determined from the received sensor alarm information. The premises status GUI may also include an alarm action interface to provide a user with a number of selectable actions, such as arming the security system, disarming the security system, suppressing a premises breach alarm, or contacting a security operations entity. An example embodiment of a premises status GUI is discussed in greater detail with reference to FIG. 7.

The alarm status (armed, disarmed, error, breached, etc.) of the alarm sensors is determined from the alarm sensor information by the security control module 510. As part of this determination, the security control module 510 may implement a status verification process whereby the alarm statuses of the alarm sensors are correlated to determine whether an alarm sensor that is signaling a potential breach is malfunctioning. To illustrate, assume that a window sensor, a sonic sensor, and a trip line sensor are positioned at a window of an external wall. In this example, it is likely that an intruder entering through the window would set off all three sensors in the process of forcibly entering the premises. Accordingly, in the event that the window sensor signals a potential breach, the security control module 510 can monitor the statuses of the sonic sensor and the trip line sensor to determine if they also register a potential breach. If not, the security control module 510 may take a predefined action, such as directing the alarm premises display module 508 to include a user notification of the alarm status of the window sensor for display at the television 100. Otherwise, if one or both of the sonic sensor and the trip line sensor is also registering a potential breach, the security control module 510 may take a more cautious predefined action, such as by sounding an alarm siren at the monitored premises and by contacting a security operations entity via, for example, the telephony interface 160.

The security control module 510, in one embodiment, initiates or performs one or more actions selected by a user while the user is interfacing with the premises diagram GUI provided by the alarm premises display module 508. For example, when presented with a notification of a potential breach via the premises diagram GUI, the user may select to suppress the alarm. Accordingly, the security control module 510 may send a reset signal to the triggered alarm sensor or the panel alarm to reset the alarm sensor. Alternatively, the user may choose to notify a security operations entity, in which case the security control module 510 may contact the security operations entity via the telephony interface 160 or the remote notification module 512. As another example, the user may choose to disarm the system, whereby the security control module 510 sends a disable signal to the alarm sensors or the alarm panel, or configures itself to ignore alarm sensor information until the system is rearmed. As yet another action selected in response to a potential breach notification, the user may request the display of video content captured by a video camera in the area of the potential breach. Accordingly, the security control module 510 may direct the alarm premises display module 408 to incorporate the video content into a video display window of the premises diagram GUI.

The security control module 510 can contact a security operations entity using either the telephony interface 160 or the remote notification module 512. Using the telephony interface 160, the security control module 510 can communicate a security status message, such as a request for security patrol, a notification of a medical emergency, or a notification of a false alarm, to a human operator via a voice synthesizer (not shown) or a prerecorded message. The security status message may further include premises breach information, such as the location and type of breach, captured video content of the location in question, and the like. Alternatively, the security module 510 may use the telephony interface 160 to provide a facsimile transmission indicating the security status message. The remote notification module 512 may also be used to transmit a digital security status message in the form of, for example, and email, an SMS message, an instant message, and the like. The digital security status message may be transmitted to its destination via, for example, the network interface 118 or the wireless interface modular card 142 of the television 100.

The remote access module 514 provides a user remote access to the security system status via a data network connected to the television 100. In one embodiment, the remote access module 514 includes a web server to provide the security system status in the form of a web page. The webpage information provided by the remote access module 514 can include, for example, an emulation of the premises diagram GUI provided by the alarm premises display module 508, including the current alarm statuses of the alarm sensors positioned at the monitored premises. In the event of a potential breach or a determined malfunction, the user can remotely initiate one or more actions via the supplied web page.

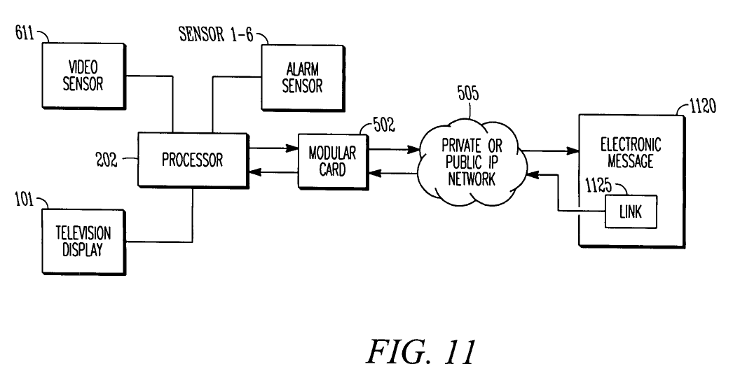

Referring to FIG. 11, an embodiment of a security system is illustrated. A processor 202 is configured to be coupled to a packet-based network 505 via a modular card 502. A television display 101, a video sensor 611, and alarm sensors 1-6 (FIG. 6) are coupled to the processor 202. The modular card 502 coupled to the processor 202 includes a control module having logic to transmit an electronic message 1120 via the network 505. The electronic message 1120 includes a link 1125 back to one or more of the television display 101, the video sensor 611, the alarm sensors 1-6, and the processor 202.

Referring to FIG. 6, an example implementation of the premises diagram generation GUI is depicted in accordance with at least one embodiment. As shown, the premises diagram generation GUI 600 includes a premises layout window 602, a sensor type selection list 604, and a structure features selection list 606. The premises layout window 602 is used to graphically display the premises layout being constructed by the user. The sensor type selection list 604 includes selectable icons for one or more sensor types. To illustrate, the sensor type selection list 504 may include an icon 508 representing a door alarm, an icon 609 representing a window alarm, an icon 610 representing an infrared/laser trip line sensor or motion sensor, and icon 611 representing a security camera, and an icon 612 representing a sonic sensor. The structure features selection list 606 includes selectable icons for one or more structural feature types, such as an icon 620 for an external wall, an icon 621 for an internal wall, and an icon 622 for a door, an icon 623 for a window, and an icon 624 for an alarm panel.

In one embodiment, the user selects icons to insert the corresponding feature into the premises layout window 602 and then altering their position, orientation, and dimensions until a layout 630 of the monitored premises, including positioned alarm sensors, is generated. Further, the user may select the sensor icons in the premises layout window 602 to input additional information regarding the selected alarm sensor, such as an alarm/disarm schedule for the particular alarm sensor, a sensitivity setting, its means of connection (e.g., wirelessly, via an alarm panel, chained via another alarm sensor), and the like. The user can also select the alarm sensor icons to input various operating parameters of rules. To illustrate, sensor 6 (a security video camera) may be configured by the user to capture video content and transmit the captured video content to the television 100 in response to a breach detected by either sensor 1 (a door sensor) or sensor 4 (a window sensor). If the user is satisfied with the created premises layout, the user may select the save button 632, or, if the user wants to start over or cancel the generation process, the user can select the cancel button 634.

Referring to FIG. 7, an embodiment of a premises diagram GUI is illustrated in accordance with at least one embodiment of the present disclosure. As depicted, the premises diagram GUI 710 includes a premises layout window 702, a system status window 704, and an action interface window 706. In this embodiment, the premises diagram GUI 700 corresponds to the premises diagram 630 described in connection with FIG. 6. The system status window 704 includes a textual or other graphical representation of the current alarm status of the alarm sensors included in the premises diagram 730. In this embodiment, the system status window 704 includes a list of each alarm sensor followed by its current alarm status. The action interface window 706 includes one or more selectable buttons associated with corresponding actions. In one embodiment, the actions represented by the selectable buttons of the action interface window 706 dynamically change in response to changing security parameters, such as in response to a potential breach, a malfunction, and the like. In this embodiment, a potential breach is detected at sensor 2 and the action interface window 706 therefore includes a selectable button 710 to initiate an action to reset the sensor 2, a selectable button 711 to initiate an action to disable the security system, and a selectable button 712 to initiate an action to notify a security operations entity.

The premises diagram 730, in one embodiment, allows a user to quickly assess the current alarm status of the monitored premises by providing an easily discernable graphical representation of the layout of the monitored premises and the alarm statuses of the alarm sensors. The premises diagram 730 may include various graphical indicators located at or near the sensor icons to identify their current statuses. To illustrate, assuming that sensor 2 indicates a potential breach while sensors 1, 3, 4, and 5 do not, an “OK” status icon 732 may be displayed near the sensors 2-5, while a “BREACH” status icon 734 may be displayed near the sensor 1. The status icons 732 and 734 further may include various graphical features, such as a green tint for an “OK” status, a red tint for a “BREACH” status, flashing text, and the like. Further, for a breached sensor, a more noticeable graphical identifier, such as a bull's eye target icon 736, may be used to allow a user to more readily identify the location of a breached sensor.

After reviewing the premises diagram 730, the user may select one or more of the selectable buttons 710, 711, or 712 of the alarm action interface 706 so as to initiate a particular action, such as the resetting of the sensor, the disabling of the system, or the notification of a security operations entity. Further, the actions available for selection may change based on the state of the alarm sensors or the monitored premises.

In another embodiment, a system includes a processor 202 that is configured to be coupled to a packet-based network 505, 510. The processor 202 is also coupled to a television display 102, a video sensor (such as sensors 1-6 in FIG. 6), an alarm sensor (such as sensors 1-6 in FIG. 6), and a modular card 147. In this embodiment, the modular card 147 includes a control module having logic to transmit an electronic message, and the electronic message includes a link back to the system. In a particular embodiment, the link back to the system provides access to the television display 102, the video sensor, and/or the alarm sensor. In another particular embodiment, the electronic message is transmitted in response to a security breach of the video sensor and/or the alarm sensor. The processor 202 has logic to display on the television display 102 a diagrammatic layout of a premises (e.g., FIG. 6) monitored by the system. The control module includes logic to transmit a notification to a third party and to provide access to the third party to a premises monitored by the system. The security control module may include logic to receive input from a user and to execute an action based on the user input, and the action may include suppressing the alarm sensor and/or resetting the alarm sensor.

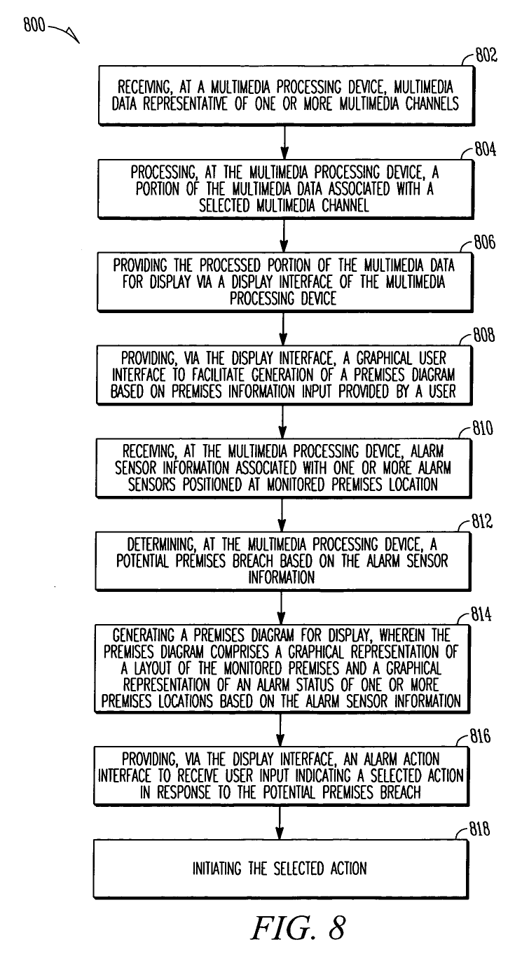

Referring to FIG. 8, an embodiment of a process 800 for providing security monitoring and multimedia processing at a multimedia processing device is illustrated in accordance with at least one embodiment of the present disclosure. The multimedia processing device may include any of a variety of devices that process video and/or audio data, such as the networked television 100 of FIG. 1, a multimedia set top box, and the like.

The process 800 includes receiving, at the multimedia processing device, multimedia data representative of one or more multimedia channels at block 802. The multimedia data may be received as, for example, a data packet-based network transmission, a terrestrial or satellite transmission, and the like. The multimedia data may be encoded based on any of a variety of encoding standards, such as the Motion Picture Experts Group (MPEG) based standard. At block 804, the method 800 includes processing, at the multimedia processing device, at least a portion of the multimedia data associated with a selected multimedia channel. Processing the portion of the multimedia data may include decoding, decrypting, scaling, or transcoding the multimedia data. The method 800 further includes providing the processed portion of the multimedia data for display via a display interface of the multimedia processing device. To illustrate, the multimedia processing device may include a set top box connected to a television via a display controller of the multimedia processing device.

Proceeding to block 808, the process 800 includes providing, via the display interface, a GUI to facilitate generation of a premises diagram based on premises information input provided by the user. An example of a premises diagram generation GUI is described in greater detail with reference to FIGS. 5 and 6. At block 810, the method 800 includes determining, at the multimedia processing device, a potential premises breach based on the alarm sensor information. The potential premises breach may be determined based on a “breached” alarm status of one or more sensors. Further, the multimedia processing device may utilize a verification process to more accurately ascertain whether there is indeed a premises breach. At block 814, the process 800 includes generating a premises diagram for display, where the premises diagram includes a graphical representation of a layout of the monitored premises and a graphical representation of an alarm status of one or more premises locations based on the alarm sensor information. An exemplary premises diagram GUI is discussed in greater detail with reference to FIGS. 6 and 7.

At block 816, the method 800 includes providing, via the display interface, an alarm action interface to receive user input indicating a selected action in response to the potential premises breach. The alarm action interface, in one embodiment, is provided as part of the premises diagram generated at block 814. At block 818, the process 800 includes initiating the selected action. In one embodiment, the selected action includes suppressing an alarm and initiating the selected action includes resetting an alarm sensor associated with the potential premises breach. In another embodiment, the selected action includes notifying a security operations entity, and the selected action includes transmitting a notification to a security operations entity, where the notification may include, for example, an email, a voice message, a facsimile transmission, and the like, and may be transmitted via a telephony interface or a data packet network interface.

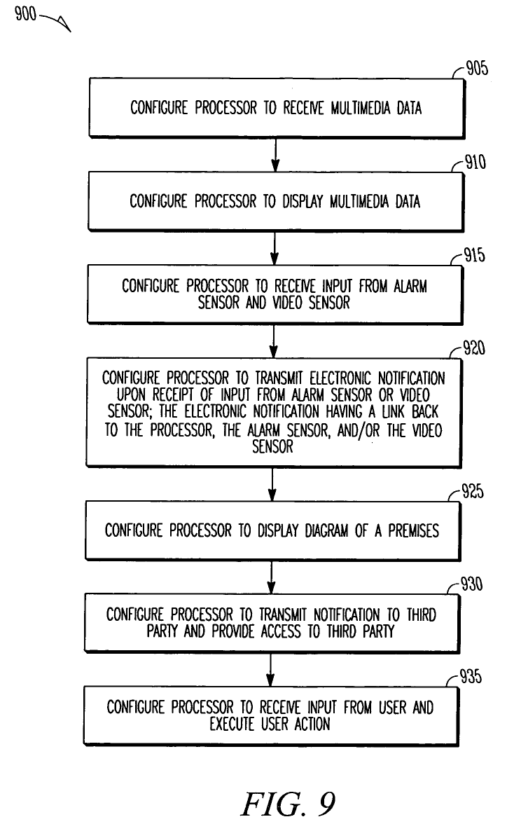

Referring to FIG. 9, an another example embodiment of a process 900 for providing security monitoring and multimedia processing at a multimedia processing device is illustrated in accordance with at least one embodiment of the present disclosure. The multimedia processing device may include any of a variety of devices that process video and/or audio data, such as the networked television 100 of FIG. 1, a multimedia set top box, and the like.

The method 900 includes configuring a television-based processor to receive multimedia data from a packet-based network at block 905. At block 910, the television-based processor is configured to display at least a portion of the multimedia data on a display unit. The television-based processor is further configured to receive input from one or more of an alarm sensor and a video sensor at block 915. At block 920, the television-based processor is configured to transmit an electronic notification when the television-based processor receives input from one or more of the alarm sensor and the video sensor. In an embodiment, this electronic notification includes a link to a premises monitored by the method 900. In an embodiment, the link provides access to the display unit, the video sensor, or the alarm sensor. In another embodiment, the electronic message is transmitted in response to a security breach sensed by the video sensor and/or the alarm sensor. In block 925, the television-based processor is configured to display on the display unit a diagrammatic layout of the premises. At block 930, the television-based processor is configured to transmit a notification to a third party and to provide access to the third party to the premises monitored by the method 900. At block 935, the television-based processor is configured to receive input from a user via the link and to execute an action using the television-based processor based on the user input. In an embodiment, that action may include suppressing the alarm sensor and/or resetting the alarm sensor.

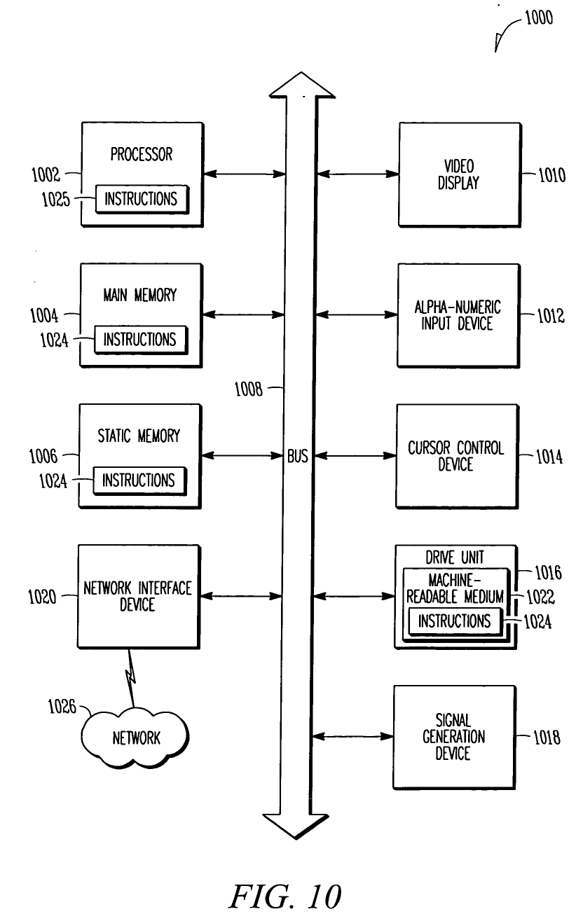

Although the security monitoring techniques are described in the context of the networked television 100 and a modular card for ease of illustration, these techniques may be implemented in other multimedia processing devices, such as a set top box, using the guidelines provided herein without departing from the scope of the present disclosure. For example, referring to FIG. 10, an illustrative embodiment of a computer system to implement one or more of the disclosed techniques is shown and designated as 1000. The computer system 1000 may include a set of instructions that can be executed to cause the computer system 1000 to any one or more of the methods or computer based functions disclosed herein. The computer system 1000 may operate as a standalone device or may be connected, for example, using a network, to other computer systems or peripheral devices.

The computer system 1000 of FIG. 10, in a networked environment, may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular phone, a web appliance, a network router, switch, or bridge, or any machine capable of executing a set of web instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (for example a central processing unit (CPU), a graphics processing unit (GPU), or both), a main memory 1004 and a static memory 1006, which communicate with each other via a bus 1008. The computer system 1000 may further include a video display unit 1010 (for example a liquid crystal display (LCD) or a cathode ray tube (CRT)). The computer system 1000 also includes an alphanumeric input device 1012 (for example a keyboard), a user interface (UI) navigation device 1014 (for example a mouse), a disk drive unit 1016, a signal generation device 1018 (for example a speaker), and a network interface device 1020.

The disk drive 1016 includes a machine readable medium 1022 on which is stored one or more sets of instructions and data structures (for example, software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004, and the processor 1002 also constituting machine readable media.

The software 1024 may further be transmitted or received over a network 1026 via the network interface device 1020 utilizing any one or a number of well-known transfer protocols (for example, HTTP).

While the machine readable medium 1022 is shown in an example embodiment to be a single medium, the term “machine readable medium” should be taken to include a single medium or multiple media (for example, a centralized or distributed database, and/or associated caches and servers) that store the one or more sets of instructions. The term “machine readable medium” shall also be taken to include any medium that is capable of storing, encoding, or carrying a set of instructions for execution by the machine and that cause the machine to perform any one or more of the methodologies of the present invention, or that is capable of storing, encoding, or carrying data structures utilized by or associated with such a set of instructions. The term “machine readable medium” shall accordingly be taken to include, but not be limited to, solid state memories, optical and magnetic media, and carrier wave signals.

The above disclosed subject matter is to be considered illustrative and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A system comprising:
a processor configured to be coupled to a packet-based network;
a television display coupled to the processor;
a video sensor coupled to the processor;
an alarm sensor coupled to the processor; and
a modular card coupled to the processor, the modular card comprising a control module having logic to transmit an electronic message;
wherein the electronic message includes a link back to one or more of the television display, the video sensor, the alarm sensor, and the processor.

2. The system of claim 1, wherein the processor comprises processor logic to display on the television display a diagrammatic layout of an area monitored by the system.

3. The system of claim 1, wherein the control module further comprises additional logic to transmit a notification to a third party and to provide access to the third party to an area monitored by the system.

4. The system of claim 1, wherein the link provides access to one or more of the television display, the video sensor, and the alarm sensor.

5. The system of claim 1, wherein the electronic message is transmitted in response to a security breach sensed by one or more of the video sensor and the alarm sensor.

6. The system of claim 1, wherein the control module further comprises additional logic to receive input and to execute an action based on the input.

7. The system of claim 6, wherein the action comprises one or more of suppressing the alarm sensor and resetting the alarm sensor.

8. A method comprising:
configuring a television-based processor to receive multimedia data from a packet-based network;
configuring the television-based processor to display at least a portion of the multimedia data on a display unit;
configuring the television-based processor to receive input from one or more of an alarm sensor and a video sensor; and
configuring the television-based processor to transmit an electronic notification when the television-based processor receives input from one or more of the alarm sensor and the video sensor;
wherein the electronic notification includes a link to the television-based processor.

9. The method of claim 8, further comprising configuring the television-based processor to display on the display unit a diagrammatic layout of an area monitored by the alarm sensor and the video sensor.

10. The method of claim 8, further comprising configuring the television-based processor to transmit a notification to a third party and to provide access to the third party to an area monitored by the alarm sensor and the video sensor.

11. The method of claim 8, wherein the link provides access to one or more of the display unit, the video sensor, and the alarm sensor.

12. The method of claim 8, wherein the electronic message is transmitted in response to a security breach sensed by one or more of the video sensor and the alarm sensor.

13. The method of claim 8, further comprising configuring the television-based processor to receive input via the link and to execute an action using the television-based processor in response to the input.

14. The method of claim 13, wherein the action comprises one or more of suppressing the alarm sensor and resetting the alarm sensor.

15. A machine readable medium having instructions thereon, which when accessed by a machine performs a method comprising:
receiving multimedia data at a television-based processor from a packet-based network;
displaying at least a portion of the multimedia data on a display unit;
receiving input from one or more of an alarm sensor and a video sensor; and
transmitting an electronic notification when the television-based processor receives input from one or more of the alarm sensor and the video sensor;
wherein the electronic notification includes a link to a monitored area.

16. The machine readable medium of claim 15, further comprising instructions for displaying on the display unit a diagrammatic layout of the area.

17. The machine readable medium of claim 15, further comprising instructions for transmitting a notification to a third party and providing access to the third party to the area monitored by the method.

18. The machine readable medium of claim 15, wherein the link provides access to one or more of the display unit, the video sensor, and the alarm sensor.

19. The machine readable medium of claim 15, wherein the electronic message is transmitted in response to a security breach sensed by one or more of the video sensor and the alarm sensor.

20. The machine readable medium of claim 15, further comprising instructions for receiving input via the link and for executing an action using the television-based processor in response to the input.
